(19) United States
(12) Patent Application Publication
(10) Pub. No.: US 2019/0138960 A1
(43) Pub. Date: May 9, 2019

(54) Information System with Embedded Insights

(71) Applicant: ADP, LLC, Roseland, NJ (US)

(72) Inventors: Xiaojing Wang, Warren, NJ (US); Uday Kovur, Hyderabad (IN); Venkata Turlapati, Roseland, NJ (US); Min Xiao, Caldwell, NJ (US); Slawomir Krysiak, Weekawken, NJ (US); Luke Green, New York, NY (US)

(21) Appl. No.: 15/804,732

(22) Filed: Nov. 6, 2017

(51) Int. Cl. G06Q 10/06

(52) U.S. Cl. CPC G06Q 10/06313

(57) ABSTRACT

A method, a computer system, and a computer program product for digitally presenting a potentially competitive resource allocation for an organization. A computer system identifies employee data for a set of employees. The computer system determines a corresponding business function of a set of business functions for each employee of the set of employees by applying a normalized business function model to the employee data. The computer system determines an aggregate allocation for each business function based on a cumulative compensation of a subset of the set of employees in the corresponding business function. The computer system determines a resource distribution for the organization based on the aggregate allocations for each of the set of business functions. The computer system compares the resource distribution for the organization to a set of benchmark distributions to determine the competitive resource allocation for the organization.

### BACKGROUND INFORMATION

### 1. Field

The present disclosure relates generally to an improved computer system and, in particular, to a method and apparatus for accessing information in a computer system. Still more particularly, the present disclosure relates to a method, a system, and a computer program product for determining and presenting a potentially competitive resource allocation for an organization.

### 2. Background

Information systems are used for many different purposes. For example, an information system may be used to process payroll to generate paychecks for employees in an organization. Additionally, an information system also may be used by a human resources department to maintain benefits and other records about employees. For example, a human resources department may manage health insurance plans, wellness plans, and other programs and organizations using an employee information system. As another example, an information system may be used to hire new employees, assign employees to projects, perform reviews for employees, and other suitable operations for the organization. As yet another example, a research department in the organization may use an information system to store and analyze information to research new products, analyze products, or for other suitable operations.

Currently used information systems include databases. These databases store information about the organization. For example, these databases store information about employees, products, research, product analysis, business plans, and other information about the organization.

Information about the employees may be searched and viewed to perform various operations within an organization. However, this type of information in currently used databases may be cumbersome and difficult to access relevant information in a timely manner that may be useful to performing an operation for the organization. For example, understanding how much capital goes into employee compensation and where that capital is being invested may be desirable for operations such as identifying new hires, selecting teams for projects, and other operations in the organization. However, because specific responsibilities and descriptions of job positions may vary among different organizations, optimal investment strategies across a business sector often cannot be determined. Therefore, relevant information is often excluded from the analysis and performance of the operation. Furthermore, identifying appropriate investments into business units for companies of a particular size and industry may take more time than desired in an information system.

Therefore, it would be desirable to have a method and apparatus that take into account at least some of the issues discussed above, as well as other possible issues. For example, it would be desirable to have a method and apparatus that overcome the technical problem of presenting a potentially competitive resource allocation for an organization.

### SUMMARY

An embodiment of the present disclosure provides a method for digitally presenting a potentially competitive resource allocation for an organization. A computer system identifies employee data for a set of employees. The computer system determines a corresponding business function of a set of business functions for each employee of the set of employees by applying a normalized business function model to the employee data. The computer system determines an aggregate allocation for each business function based on a cumulative compensation of a subset of the set of employees in the corresponding business function. The computer system determines a resource distribution for the organization based on the aggregate allocations for each of the set of business functions. The computer system compares the resource distribution for the organization to a set of benchmark distributions to determine the competitive resource allocation for the organization.

Another embodiment of the present disclosure provides a computer system comprising a display system and a resource allocation system in communication with the display system. The resource allocation system is configured to identify an employee data for a set of employees. The resource allocation system is further configured to determine a corresponding business function of a set of business functions for each employee of the set of employees by applying a normalized business function model to the employee data. The resource allocation system is further configured to determine an aggregate allocation for each business function based on a cumulative compensation of a subset of the set of employees in the corresponding business function. The resource allocation system is further configured to determine a resource distribution for the organization based on the aggregate allocations for each of the set of business functions. The resource allocation system is further configured to compare the resource distribution for the organization to a set of benchmark distributions to determine the competitive resource allocation for the organization.

Yet another embodiment of the present disclosure provides a computer program product for presenting a potentially competitive resource allocation for an organization. The computer program product comprises a computer readable storage media and program code, stored on the computer readable storage media. The program code includes program code for identifying employee data for a set of employees. The program code includes program code for determining a corresponding business function of a set of business functions for each employee of the set of employees by applying a normalized business function model to the employee data. The program code includes program code for determining an aggregate allocation for each business function based on a cumulative compensation of a subset of the set of employees in the corresponding business function. The program code includes program code for determining a resource distribution for the organization based on the aggregate allocations for each of the set of business functions. The program code includes program code for comparing the resource distribution for the organization to a set of benchmark distributions to determine the competitive resource allocation for the organization.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a resource information environment in accordance with an illustrative embodiment;

FIG. 2 is an illustration of a block diagram for a data flow for identifying a set of benchmark distributions for determining a competitive resource allocation in accordance with an illustrative embodiment;

FIG. 3 is an illustration of a data flow for classifying employees into a number of business functions depicted in accordance with an illustrative embodiment;

FIG. 4 is an illustration of a data flow for determining a corresponding business function for employees of an organization in accordance with an illustrative embodiment;

FIG. 5 is an illustration of a graphical user interface displaying a competitive resource allocation in accordance with an illustrative embodiment;

FIG. 6 is an illustration of a flowchart of a process for digitally presenting a potentially competitive resource allocation for an organization in accordance with an illustrative embodiment; and

FIG. 7 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that an employer may need information about capital allocation when performing certain operations. Furthermore, identifying appropriate investments into business units for companies of a particular size and industry may also be desirable. The illustrative embodiments also recognize and take into account that searching information systems for successful allocations may be more cumbersome and time-consuming than desirable. For example, because specific responsibilities and descriptions of job positions may vary among different organizations, optimal investment strategies across a business sector often cannot be determined.

The illustrative embodiments also recognize and take into account that digitally presenting a potentially competitive resource allocation for an organization may facilitate accessing information about appropriate investments into business units for companies of a particular size and industry when performing operations for an organization. The illustrative embodiments also recognize and take into account that identifying a potentially competitive resource allocation may still be more difficult than desired. The illustrative embodiments also recognize and take into account that machine learning is a technology that can now be incorporated in finding patterns and trends in corporate resource allocation. The illustrative embodiments further recognize and take into account that machine learning allows for the construction of corporate resource allocation models and subsequently presenting these models digitally.

Thus, the illustrative embodiments provide a method and apparatus for digitally presenting a potentially competitive resource allocation for an organization. In one illustrative example, a computer system identifies employee data for a set of employees. The computer system determines a corresponding business function of a set of business functions for each employee of the set of employees by applying a normalized business function model to the employee data. The computer system determines an aggregate allocation for each business function based on a cumulative compensation of a subset of the set of employees in the corresponding business function. The computer system determines a resource distribution for the organization based on the aggregate allocations for each of the set of business functions. The computer system compares the resource distribution for the organization to a set of benchmark distributions based on machine learning to determine the competitive resource allocation for the organization.

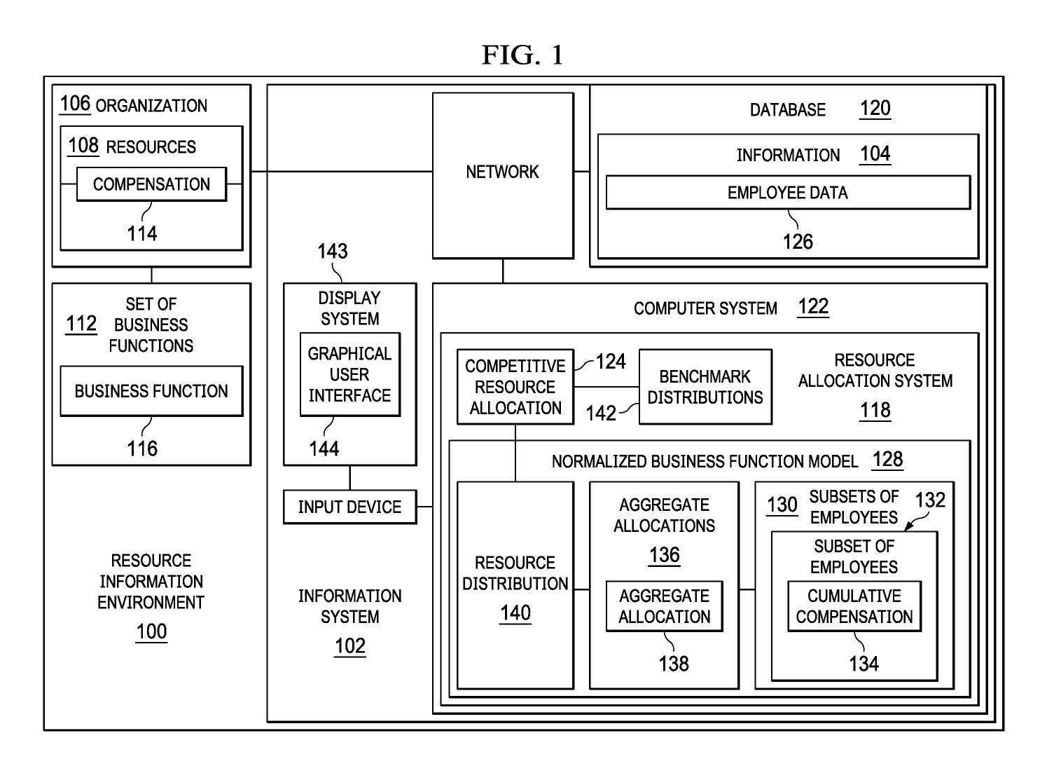

With reference now to the figures and, in particular, with reference to FIG. 1, an illustration of a block diagram of resource information environment 100 is depicted in accordance with an illustrative embodiment. Resource information environment 100 includes information system 102.

Information system 102 may take different forms. For example, information system 102 may be selected from one of an employee information system, a research information system, a sales information system, an accounting system, a payroll system, a human resources system, or some other type of information system that stores and provides access to information 104 about organization 106.

Information system 102 manages information 104. Information 104 can include information about organization 106. Information 104 about organization 106 may include, for example, at least one of information about people, products, research, product analysis, business plans, financials, or other information relating to organization 106.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Organization 106 may be, for example, a corporation, a partnership, a charitable organization, a city, a government agency, or some other suitable type of organization. As depicted, organization 106 includes resources 108 and employees 110.

Resources 108 are resources used by organization 106 to perform set of business functions 112. Resources 108 may include financial resources, physical resources, inventory, human skills, production resources, or information technology. Resources 108 are allocated to employees 110 as compensation 114.

As depicted, employees 110 are people who are employed by or associated with organization 106 for which information system 102 is implemented. For example, employees 110 can include at least one of employees, administrators, managers, supervisors, and third parties associated with organization 106.

Organization 106 allocates resources 108 to accomplish one or more of business function 116 in set of business functions 112. As used herein, business function 116 is any activity performed by employees 110 in furtherance of goals of organization 106 or in support of operations of organization 106.

In this illustrative example, information system 102 includes different components. As depicted, information system 102 includes resource allocation system 118 and database 120. Resource allocation system 118 and database 120 may be implemented in computer system 122.

Computer system 122 is a physical hardware system and includes one or more data processing systems. When more than one data processing system is present, those data processing systems may be in communication with each other using a communications medium. The communications medium may be a network. The data processing systems may be selected from at least one of a computer, a server computer, a workstation, a tablet computer, a laptop computer, a mobile phone, or some other suitable data processing system.

In this illustrative example, resource allocation system 118 generates competitive resource allocation 124. Competitive resource allocation 124 is a suggested allocation of resources 108 across set of business functions 112 based on identified financial growth characteristics of other organizations. By generating competitive resource allocation 124, resource allocation system 118 enables the performance of operations that may more efficiently support set of business functions 112 of organization 106. For example, competitive resource allocation 124 allows organization 106 to allocate resources 108 across set of business functions 112 based on identified financial growth characteristics of other organizations.

Resource allocation system 118 may be implemented in software, hardware, firmware, or a combination thereof. When software is used, the operations performed by resource allocation system 118 may be implemented in program code configured to run on hardware, such as a processor unit. When firmware is used, the operations performed by resource allocation system 118 may be implemented in program code and data and stored in persistent memory to run on a processor unit. When hardware is employed, the hardware may include circuits that operate to perform the operations in resource allocation system 118.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

In one illustrative example, resource allocation system 118 identifies employee data 126 within information 104. Employee data 126 includes data about employees 110 in the context of organization 106.

In this illustrative example, resource allocation system 118 can include a number of different components. As used herein, “a number of” is one or more components. As depicted, resource allocation system 118 includes normalized business function model 128.

Normalized business function model 128 is a statistical model that determines a corresponding one of business function 116 from one of set of business functions 112 for each of employees 110 by statistically modeling employee data 126. Normalized business function model 128 places groups of employees 110 into subsets of employees 130 corresponding to set of business functions 112. For example, subset of employees 132 corresponds to business function 116.

In this illustrative example, subset of employees 132 includes cumulative compensation 134. Cumulative compensation 134 is the aggregate compensation of subset of employees 132. Only cumulative compensation 134 for subset of employees 132 is shown for clarity. However, each of subsets of employees 130 also includes a respective cumulative compensation based on the aggregate compensation of employees 110 corresponding to that particular subset.

Based on the cumulative compensations for each of subsets of employees 130, normalized business function model 128 determines aggregate allocations 136 for each of subsets of employees 130. Aggregate allocations 136 are amounts of resources 108 allocated to each of set of business functions 112 based on cumulative compensation 134 of employees 110 that have been modeled to the respective business function. For example, aggregate allocation 138 is an amount of resources 108 allocated to business function 116 based on cumulative compensation 134 of subset of employees 132.

Based on aggregate allocations 136 for each of the set of business functions 112, normalized business function model 128 determines resource distribution 140 for organization 106. Resource distribution 140 is a comparison of aggregate allocations 136 across set of business functions 112. In one illustrative example, resource distribution 140 can be graphically indicated as a fractional amount of resources 108 that are allocated to each one of business function 116.

Resource allocation system 118 compares resource distribution 140 of organization 106 to a set of benchmark distributions 142 to determine competitive resource allocation 124. In this illustrative example, benchmark distributions 142 are resource allocations of other organizations across set of business functions 112. By generating competitive resource allocation 124, resource allocation system 118 enables the performance of operations that may more efficiently support set of business functions 112 of organization 106. For example, competitive resource allocation 124 allows organization 106 to allocate resources 108 across set of business functions 112 based on identified financial growth characteristics of other organizations.

Computer system 122 can display competitive resource allocation 124 on display system 143. In this illustrative example, display system 143 can be a group of display devices. A display device in display system 143 may be selected from one of a liquid crystal display (LCD), a light emitting diode (LED) display, an organic light emitting diode (OLED) display, and other suitable types of display devices.

In this illustrative example, competitive resource allocation 124 is displayed on display system 143 in graphical user interface 144. An operator may interact with graphical user interface 144 through user input generated by one or more user input devices, such as, for example, a mouse, a keyboard, a trackball, a touchscreen, a stylus, or some other suitable type of input device.

By determining competitive resource allocation 124, resource allocation system 118 enables a more efficient performance of operations for organization 106 in support of set of business functions 112. For example, operations, such as, but not limited to, at least one of hiring, benefits administration, payroll, performance reviews, forming teams for new products, assigning research projects, or other suitable operations for organization 106 that are performed consistent with competitive resource allocation 124, allows organization 106 to allocate resources 108 across set of business functions 112 based on identified financial growth characteristics of other organizations.

For example, competitive resource allocation 124 allows organization 106 to perform operations in a manner that is consistent with the resource allocations of other successful organizations based on identified financial growth characteristics of those successful organizations. Additionally, competitive resource allocation 124 allows organization 106 to perform operations in a manner that may not be consistent with the resource allocations of unsuccessful organizations based on identified financial growth characteristics of those unsuccessful organizations.

In this illustrative example, resource allocation system 118 digitally presents a potentially competitive resource allocation 124 for organization 106. Resource allocation system 118 identifies employee data 126 corresponding to business function 116 of set of business functions 112 for each employee of the set of employees 110 by applying normalized business function model 128 to employee data 126. Resource allocation system 118 determines aggregate allocations 136 for each of set of business functions 112 based on cumulative compensation 134 of subset of the employees 132 in the corresponding business function 116. Resource allocation system 118 determines a resource distribution for organization 106 based on aggregate allocations 136 for each of set of business functions 112. Resource allocation system 118 compares resource distribution 140 for organization 106 to a set of benchmark distributions 142 to determine competitive resource allocation 124 for organization 106.

The illustrative example in FIG. 1 and the examples in the other subsequent figures provide one or more technical solutions to overcome a technical problem of determining a competitive allocation of resources for an organization that make the performance of operations for an organization more cumbersome and time-consuming than desired. For example, organization 106 performs operations consistent with competitive resource allocation 124; when organization 106 allocates resources 108 across set of business functions 112 in a manner that is consistent with the resource allocations of other successful organizations based on identified financial growth characteristics.

In this manner, the use of resource allocation system 118 has a technical effect of determining competitive resource allocation 124 based on the set of benchmark distributions 142, thereby reducing time, effort, or both in the performance of operations supporting set of business functions 112. In this manner, operations performed for organization 106 may be performed more efficiently as compared to currently used systems that do not include resource allocation system 118. For example, operations, such as, but not limited to, at least one of hiring, benefits administration, payroll, performance reviews, forming teams for new products, assigning research projects, or other suitable operations for organization 106, performed consistent with competitive resource allocation 124 allows organization 106 to allocate resources 108 across set of business functions 112 based on identified financial growth characteristics of other organizations.

As a result, computer system 122 operates as a special purpose computer system in which resource allocation system 118 in computer system 122 enables determining of competitive resource allocation 124 from employee data 126 and benchmark distributions 142 based on normalized business function model 128. For example, resource allocation system 118 uses normalized business function model 128 to classify employees 110 into subsets of employees 130 corresponding to set of business functions 112. Resource allocation system 118 determines aggregate allocations 136 for each of set of business functions 112 based on cumulative compensation 134 of subset of employees 132 in the corresponding one of business function 116. Resource allocation system 118 determines a resource distribution for organization 106 based on aggregate allocations 136 for each of set of business functions 112. Resource allocation system 118 compares resource distribution 140 for organization 106 to a set of benchmark distributions 142 to determine competitive resource allocation 124 for organization 106. When competitive resource allocation 124 is determined in this manner, competitive resource allocation 124 may be relied upon to perform operations for organization 106 in a manner that is consistent with the resource allocations of other successful organizations based on identified financial growth characteristics.

Thus, resource allocation system 118 transforms computer system 122 into a special purpose computer system as compared to currently available general computer systems that do not have resource allocation system 118. Currently used general computer systems do not reduce the time or effort needed to determine potentially competitive resource allocation 124 based on employee data 126 and benchmark distributions 142. Further, currently used general computer systems do not provide for determining competitive resource allocation 124 based on normalized business function model 128.

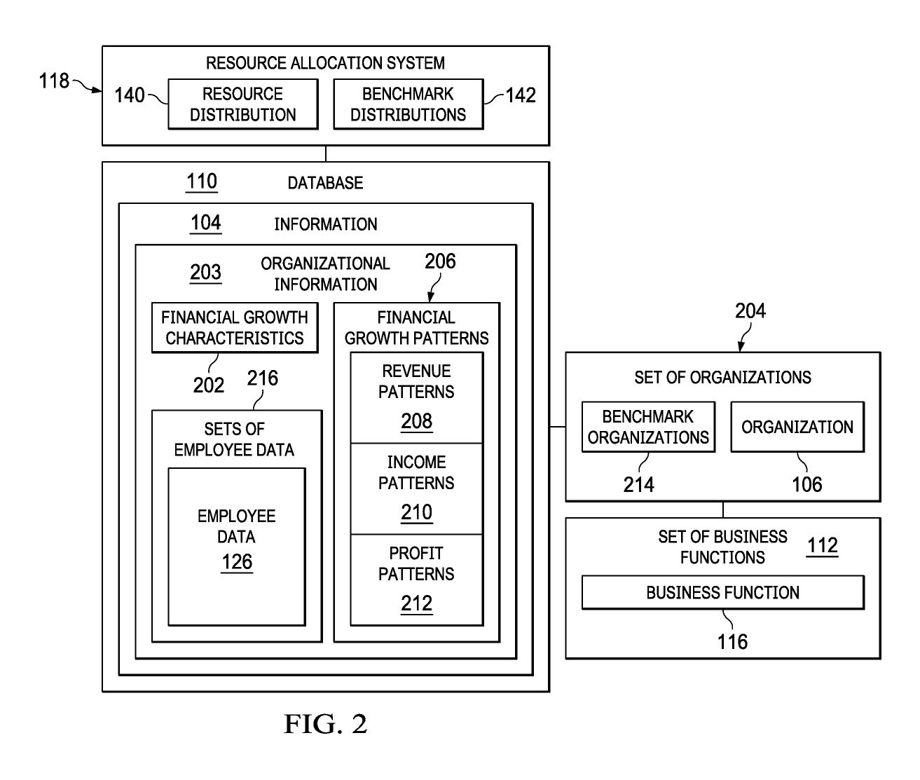

With reference next to FIG. 2, an illustration of a block diagram of data flow for identifying a set of benchmark distributions for determining a competitive resource allocation is depicted in accordance with an illustrative example. The data flow is an illustrative example for identifying benchmark distributions, such as benchmark distributions 142.

As depicted, information 104 includes organizational information 203. Organizational information 203 is information about set of organizations 204. Organizational information 203 includes financial growth characteristics 202 for set of organizations 204. Financial growth characteristics 202 are characteristics of set of organizations 204 that help to identify a financial status of set of organizations 204.

Financial growth patterns 206 show changes over a period of time for a corresponding one of financial growth characteristics 202 of one or more of set of organizations 204. Financial growth patterns 206 may be expressed in raw dollar amounts or as a percentage. Financial growth patterns 206 may or may not be adjusted for inflation. Resource allocation system 118 can identify a set of financial growth patterns 206 for set of organizations 204 within information 104. Financial growth patterns 206 can include, for example, but are not limited to, revenue patterns 208, income patterns 210, and profit patterns 212.

Revenue patterns 208 are changes in the amounts received by set of organizations 204 from selling main goods or services to its customers over a period of time. Revenue can be one form of resources, such as resources 108 shown in block form in FIG. 1, for each set of organizations 204.

Income patterns 210 are changes in the amounts received by set of organizations 204 in the total earnings of set of organizations 204. These earnings can be from primary busines activities of set of organizations 204, as well as any other activity which is not regularly undertaken as part of the primary business activities of set of organizations 204. Income can be one form of resources, such as resources 108, shown in block form in FIG. 1, for each set of organizations 204.

Profit patterns 212 are changes in the remaining amounts after deducting expenses incurred in generating revenue from the revenue of set of organizations 204. Profit patterns 212 can include patterns for gross profits, net profits, and combinations thereof. Profits can be one form of resources such as resources 108, shown in block form in FIG. 1, for each set of organizations 204.

As depicted, set of organizations 204 includes a set of benchmark organizations 214. Resource allocation system 118 determines the set of benchmark organizations 214 by selecting the set of benchmark organizations 214 from set of organizations 204 based on the set of financial growth patterns 206.

In one illustrative example, the set of benchmark organizations 214 may be selected based on positive growth of financial growth characteristics 202 as indicated by financial growth patterns 206. Alternatively, the set of benchmark organizations 214 may be selected based on negative growth of financial growth characteristics 202 as indicated by financial growth patterns 206.

As depicted, organizational information 203 includes sets of employee data 216. Sets of employee data 216 are employee data, similar to employee data 126, within the context of corresponding ones of set of organizations 204. In this illustrative example, resource allocation system 118 determines a set of benchmark distributions 142 based on the sets of employee data 216 corresponding to the set of benchmark organizations 214.

In this illustrative example, benchmark distributions 142 are resource allocations of benchmark organizations 214 across set of business functions 112. In one illustrative example, benchmark distributions 142 can be graphically indicated as a fractional amount of resources that are allocated to each of set of business functions 112 by benchmark organizations 214. In this illustrative example, resource allocation system 118 determines benchmark distributions 142 across a set of financial growth characteristics 202.

Continuing with the present example, resource allocation system 118 compares resource distribution 140 for organization 106 to benchmark distributions 142 across the number of financial growth characteristics 202 to determine competitive resource allocation 124, as shown in block form in FIG. 1, for organization 106. By generating competitive resource allocation 124, resource allocation system 118 enables the performance of operations that may more efficiently support set of business functions 112 of organization 106. For example, competitive resource allocation 124 allows organization 106 to allocate resources 108, as shown in block form in FIG. 1, across set of business functions 112 based on identified ones of financial growth characteristics 202 of benchmark organizations 214.

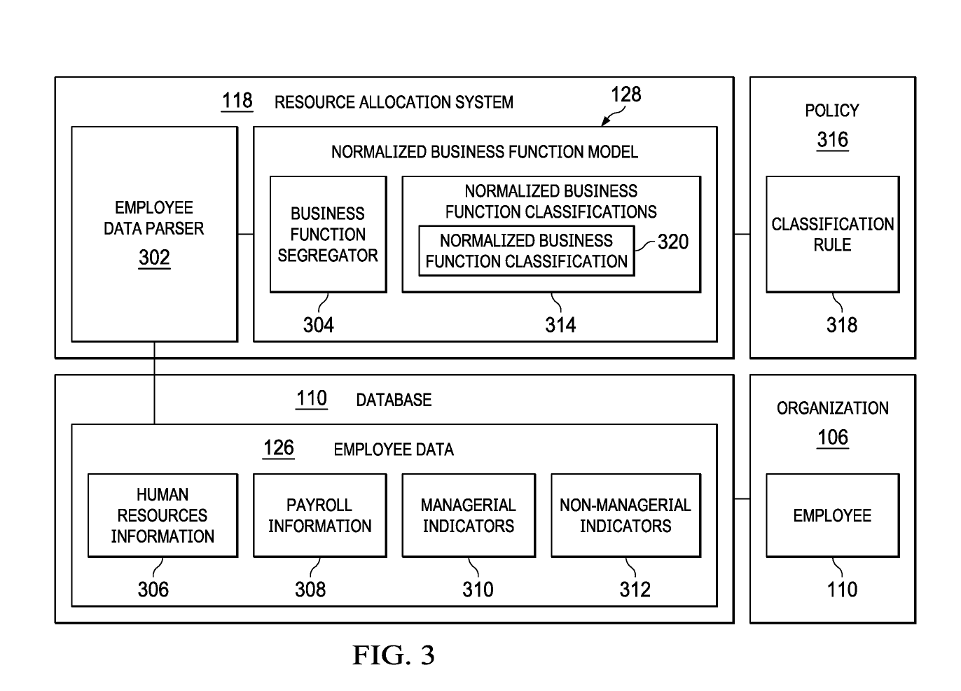

With reference next to FIG. 3, an illustration of a block diagram of a data flow for classifying employees into a number of business functions is depicted in accordance with an illustrative embodiment. As depicted, resource allocation system 118 uses normalized business function model 128 to classify employees 110 into one of normalized business function classifications 314 based on employee data 126.

As depicted, resource allocation system 118 includes a number of different components. As used herein, “a number of” means one or more different components. As depicted, resource allocation system 118 includes employee data parser 302 and business function segregator 304 of normalized business function model 128.

Resource allocation system 118 includes employee data parser 302. Employee data parser 302 identifies and parses employee data 126 for data about employees 110 of organization 106.

In this illustrative example, employee data 126 includes data about employees 110 in the context of organization 106. Employee data parser 302 parses employee data 126 for information indicative of one or more of set of business functions 112, shown in block form in FIG. 1.

In this illustrative example, employee data 126 includes a number of different types of data. As depicted, employee data 126 includes human resources information 306, payroll information 308, managerial indicators 310, and non-managerial indicators 312.

Human resources information 306 is information in employee data 126 that is indicative of which of set of business functions 112 that the responsibilities of employees 110 most directly contribute to. Human resources information 306 can include, for example, but not limited to, an employee reporting hierarchy information of employees 110, an Employee Information Report (EEO-1) of employees 110, a Standard Occupational Classification (SOC) of employees 110, a job title of employees 110, an EEO-1 job category of employees 110, a North American Industry Classification System (NAICS) class of employees 110, a salary grade of employees 110, an age of employees 110, and a tenure of employees 110 at organization 106, as well as other possible information indicative of which of set of business functions 112 that the responsibilities of employees 110 most directly contribute to.

Payroll information 308 is information in employee data 126 that is indicative of a compensation of employees 110 by organization 106. Payroll information 308 can include, for example, but not limited to, an annual base salary of employees 110, a bonus ratio of employees 110, and an overtime pay of employees 110. Payroll information 308 can include variable pay earnings including, but not limited to, different types of bonuses, tips, commissions, and stock options. Payroll information 308 can include other possible information indicative of which of set of business functions 112 that the responsibilities of employees 110 most directly contribute to.

Managerial indicators 310 are information in employee data 126 that indicate a managerial position of an employee within organization 106. Managerial indicators 310 can include, for example, but not limited to, a specific data entry of a managerial indication in employee data 126, a position of employees 110 in a reporting hierarchy of organization 106, a Standard Occupational Classification (SOC) of employees 110, a manager level description in employee data 126, and an Employee Information Report (EEO-1) of employees 110.

Non-managerial indicators 312 are information in employee data 126 that indicate a non-managerial position of employees 110 within organization 106. Non-managerial indicators 312 can include, for example, but not limited to, a specific data entry of a non-managerial indication in employee data 126, a position of employees 110 in a reporting hierarchy of organization 106, a non-managerial level description in employee data 126, an Employee Information Report (EEO-1) of employees 110, and a Standard Occupational Classification (SOC) of employees 110.

As depicted, normalized business function model 128 of resource allocation system 118 includes business function segregator 304. Business function segregator 304 segregates employees 110 into a number of normalized business function classifications 314, which can be one of set of business functions 112 shown in block form in FIG. 1, based on information parsed from employee data 126 by employee data parser 302.

In this illustrative example, business function segregator 304 segregates employees 110 into one of normalized business of function classifications 314 using policy 316. In this illustrative example, policy 316 includes one or more rules that are used to segregate employees 110 into normalized business function classifications 314. Policy 316 also may include data used to apply one or more rules. As used herein, “a group of,” when used with reference to items, means one or more items. For example, “a group of rules” is one or more rules.

As depicted, resource allocation system 118 includes normalized business function model 128. Normalized business function model 128 applies business function segregator 304 to a group of employees 110 into one of normalized business function classifications 314 based on a statistical comparison of employee data 126 to other grouped data within normalized business function classifications 314. Normalized business function model 128 groups employees 110 into one of normalized business function classifications 314 based on a statistical classification model, which is trained via supervised learning on a large set of employee data, such as sets of employee data 214 shown in block form in FIG. 2.

In this illustrative example, normalized business function model 128 classifies employees 110 into one of normalized business function classifications 314 using policy 316. In this illustrative example, policy 316 consists of classification rule 318. In this illustrative example, classification rule 318 is a rule for grouping each of employees 110 into a corresponding most similar one of normalized business function classifications 314. For example, normalized business function model 128 can apply policy 316 to classify employees 110 into one of normalized business function classifications 314 based on a statistical classification model, which is trained via supervised learning on a large set of employee data, such as employee data 214 of FIG. 2.

As depicted, normalized business function model 128 is trained on a large set of employee data. Each of normalized business function classifications 314 can be associated with some characteristics of employee data, such as employee data 214 of FIG. 2. Normalized business function model 128 is able to group each employee into one of normalized business function classifications 314 with a corresponding confidence score.

As depicted, each of normalized business function classifications 314 represents one of subsets of employees 130, shown in block form in FIG. 1. For example, subset of employees 132, also shown in block form in FIG. 1, is classified into normalized business function classification 320 based on similarities between employee data 126 of subset of employees 132 and other data that is grouped into normalized business function classification 320. In this manner, classification rule 318 groups employees 110 into one of normalized business function classifications 314 in such a way that set of employee data 126 for subset of employees 132 in normalized business function classification 320 is more similar to each other than to other data grouped into others of normalized business function classifications 314.

In this manner, resource allocation system 118 determines a corresponding business function for each of employees 110 based on information parsed from employee data 126 in a manner that meets policy 316. When employees 110 are segregated into one of normalized business function classifications 314 based on information parsed from employee data 126, competitive resource allocation 124, as shown in block form in FIG. 1, may be relied upon to perform operations for organization 106 in a manner that is consistent with the resource allocations of other successful organizations based on identified financial growth characteristics.

In an illustrative example, normalized business function classifications 314 can include one or more normalized business function classification 320. For example, normalized business function classification 320 can represent an accounting and finance business function, an administration business function, a communications business function, a consulting business function, a human resources business function, an information technology business function, a legal business function, a logistics and distribution business function, a marketing and sales business function, an operations business function, a product development business function, a services business function, and a supports business function.

Normalized business function classification 320 can represent business function 116 shown in block form in FIG. 1 that is an accounting and finance business function. An accounting and finance business function encompasses accounting, economics, taxation, business laws, and all other fields contributory to the whole process of acquiring and utilizing resources 108, as shown in block form in FIG. 1, for the benefit of organization 106. In an illustrative example, employee data 126 for subset of employees 132 is indicative of responsibilities within organization 106 that most directly relate to an accounting and finance business function of organization 106. Subset of employees 132 is grouped into normalized business function classification 320, which in the current example corresponds to business function 116 shown in block form in FIG. 1 that is an accounting and finance business function.

Normalized business function classification 320 can represent business function 116 of FIG. 1 that is an administration business function. An administration business function encompasses the performance or management of business operations and decision-making, as well as the efficient organization of people and other resources to direct activities toward common goals and objectives for organization 106. In an illustrative example, employee data 126 for subset of employees 132 is indicative of responsibilities within organization 106 that most directly relate to an administrative business function of organization 106. Subset of employees 132 is grouped into normalized business function classification 320, which in the current example corresponds to business function 116 of FIG. 1 that is an administrative business function.

Normalized business function classification 320 can represent business function 116 of FIG. 1 that is a communications business function. A communications business function encompasses communications among employees 110 of organization 106. A communications business function can include producing and delivering messages and campaigns on behalf of management, facilitating two-way dialogue among employees 110 and developing the communication skills of employees 110. In an illustrative example, employee data 126 for subset of employees 132 is indicative of responsibilities within organization 106 that most directly relate to a communications function of organization 106. Subset of employees 132 is grouped into normalized business function classification 320, which in the current example corresponds to business function 116 of FIG. 1 that is a communications business function.

Normalized business function classification 320 can represent business function 116 of FIG. 1 that is a consulting business function. A consulting business function encompasses responsibilities primarily directed to the analysis of existing organizational problems and the development of plans for improvement. In an illustrative example, employee data 126 for subset of employees 132 is indicative of responsibilities within organization 106 that most directly relate to a consulting business function of organization 106. Subset of employees 132 is grouped into normalized business function classification 320, which in the current example corresponds to business function 116 of FIG. 1 that is a consulting business function.

Normalized business function classification 320 can represent business function 116 of FIG. 1 that is a human resources business function. A human resources business function involves operations and responsibilities related to the relationship between organization 106 and employees 110, supporting and managing the organization's people and associated processes. In an illustrative example, employee data 126 for subset of employees 132 is indicative of responsibilities within organization 106 that most directly relate to a human resources business function of organization 106. Subset of employees 132 is grouped into normalized business function classification 320, which in the current example corresponds to business function 116 of FIG. 1 that is a human resources business function.

Normalized business function classification 320 can represent business function 116 of FIG. 1 that is an information technology business function. An information technology business function involves operations and responsibilities that support technology resources, including computer hardware, software, data, networks, and data center facilities, as well as the maintenance of those resources. In an illustrative example, employee data 126 for subset of employees 132 is indicative of responsibilities within organization 106 that most directly relate to an information technology business function of organization 106. Subset of employees 132 is grouped into normalized business function classification 320, which in the current example corresponds to business function 116 of FIG. 1 that is an information technology business function.

Normalized business function classification 320 can represent business function 116 of FIG. 1 that is a legal business function. A legal business function involves operations and responsibilities that handles legal issues that may arise in the course of business of organization 106. In an illustrative example, employee data 126 for subset of employees 132 is indicative of responsibilities within organization 106 that most directly relate to a legal business function of organization 106. Subset of employees 132 is grouped into normalized business function classification 320, which in the current example corresponds to business function 116 of FIG. 1 that is a legal business function.

Normalized business function classification 320 can represent business function 116 of FIG. 1 that is a logistics and distribution business function. A logistics and distribution business function encompasses operations and responsibilities directed to the supply chain flow and storage of goods from point of origin to the point of consumption, including transportation, shipping, receiving, and storage. In an illustrative example, employee data 126 for subset of employees 132 is indicative of responsibilities within organization 106 that most directly relate to a logistics and distribution business function of organization 106. Subset of employees 132 is grouped into normalized business function classification 320, which in the current example corresponds to business function 116 of FIG. 1 that is a logistics and distribution business function.

Normalized business function classification 320 can represent business function 116 of FIG. 1 that is a marketing and sales business function. A marketing and sales business function encompasses operations and responsibilities directed towards increasing revenues for organization 106 through the promotion and sale of products and services of organization 106. In an illustrative example, employee data 126 for subset of employees 132 is indicative of responsibilities within organization 106 that most directly relate to a marketing and sales business function of organization 106. Subset of employees 132 is grouped into normalized business function classification 320, which in the current example corresponds to business function 116 of FIG. 1 that is a marketing and sales business function.

Normalized business function classification 320 can represent business function 116 of FIG. 1 that is an operations business function. An operations business function encompasses operations and responsibilities directed to the design and control of processes for producing goods and/or services of organization 106. In an illustrative example, employee data 126 for subset of employees 132 is indicative of responsibilities within organization 106 that most directly relate to and operations function of organization 106. Subset of employees 132 is grouped into normalized business function classification 320, which in the current example corresponds to business function 116 of FIG. 1 that is an operations business function.

Normalized business function classification 320 can represent business function 116 of FIG. 1 that is a product development business function. A product development business function encompasses operations and responsibilities directed to the creation, innovation, and design of products produced by organization 106. In an illustrative example, employee data 126 for subset of employees 132 is indicative of responsibilities within organization 106 that most directly relate to a product development business function of organization 106. Subset of employees 132 is grouped into normalized business function classification 320, which in the current example corresponds to business function 116 of FIG. 1 that is a product development business function.

Normalized business function classification 320 can represent business function 116 of FIG. 1 that is a services business function. A services business function encompasses operations and responsibilities directed to interacting with customers of organization 106 regarding inquiries, complaints, and orders. In an illustrative example, employee data 126 for subset of employees 132 is indicative of responsibilities within organization 106 that most directly relate to a services business function of organization 106. Subset of employees 132 is grouped into normalized business function classification 320, which in the current example corresponds to business function 116 of FIG. 1 that is a services business function.

Normalized business function classification 320 can represent business function 116 of FIG. 1 that is a supports business function. A supports business function encompasses ancillary (supporting) activities carried out by organization 106 in order to permit or facilitate the operation of others of set of business functions 112. In an illustrative example, employee data 126 for subset of employees 132 is indicative of responsibilities within organization 106 that most directly relate to a supports business function of organization 106. Subset of employees 132 is grouped into normalized business function classification 320, which in the current example corresponds to business function 116 of FIG. 1 that is a supports function.

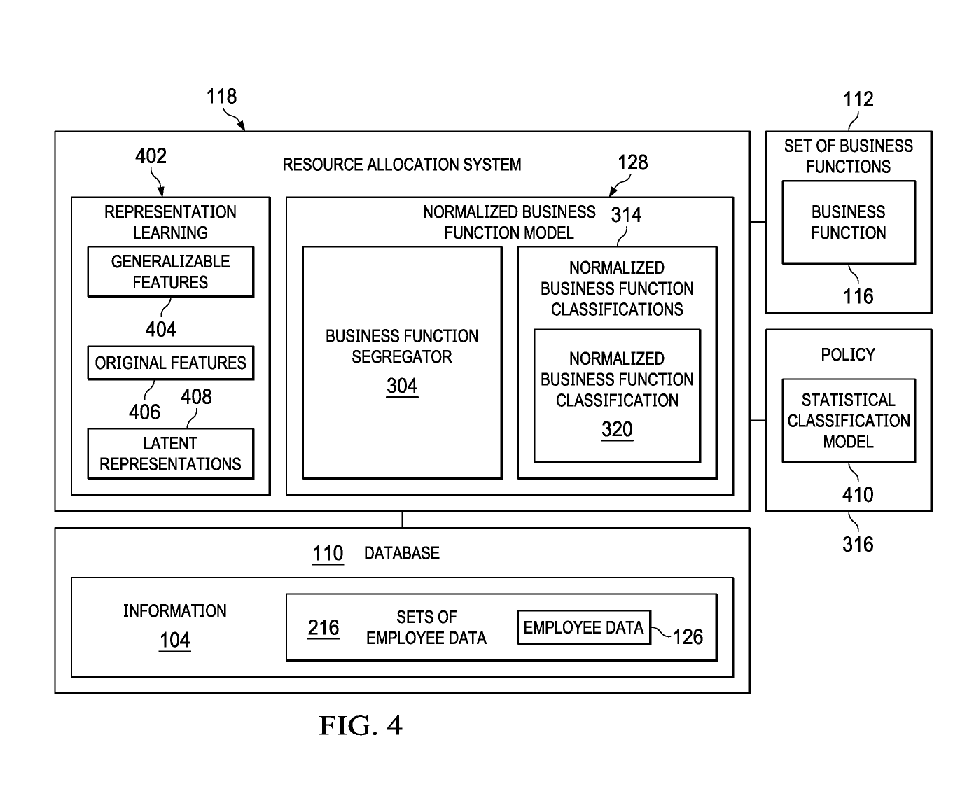

With reference next to FIG. 4, an illustration of a block diagram of data flow for determining a corresponding business function for employees of an organization is depicted in accordance with an illustrative embodiment. As depicted, resource allocation system 118 determines subsets of employees 130, as seen in block form in FIG. 1, for employees 110 of organization 106.

As depicted, normalized business function model 128 of resource allocation system 118 includes a number of different components. As depicted, normalized business function model 128 includes representation learning 402 and business function segregator 304.

Normalized business function model 128 includes representation learning 402. Representation learning 402 is a set of techniques that learn generalizable features 404 indicative of a particular one of set of business functions 112 by observing sets of employee data 214 for a set of organizations, such as set of organizations 204 of FIG. 2.

Generalizable features 404 are variables of compressed data that are inferred from representation learning 402. In this illustrative example, generalizable features 404 are data compressed from sets of employee data 214 that best explain archetypical features of each of normalized business function classifications 314, or best distinguishes normalized business function classification 320 from others of normalized business function classifications 314. In this illustrative example, generalizable features 404 may be derived from sets of employee data 214 by compressing sets of employee data 214 into a preset number of normalized business function classifications 314, which can be represented by lower-dimensional dense feature vectors.

In this illustrative example, sets of employee data 214 contains various original features 406, which may be fed into a representation learning stage to produce latent representations 408, including, but not limited to, word and title embeddings.

As depicted, normalized business function model 128 includes business function segregator 304. Business function segregator 304 determines a corresponding one of set of business functions 112 for each of employees 110 based on normalized business function model 128. In this illustrative example, business function segregator 304 determines one of normalized business function classifications 314 for subset of employees 132 using policy 316. In this illustrative example, policy 316 includes a group of rules that are used to determine corresponding ones of normalized business function classifications 314 for employees 110 represented by employee data 126. In this illustrative example, policy 316 includes statistical classification model 410. Statistical classification model 410 is a model for classifying employee data 126 for employees 110 into a corresponding one of normalized business function classifications 314. Statistical classification model 410 can be based on machine learning algorithms, such as, for example, but not limited to, decision trees, random forest models, generalized linear models, gradient boosting machines, and multi-layer feed-forward neural networks.

As illustrated, statistical classification model 410 uses generalizable features 404 and latent representations 408 to perform statistical classification on sets of employee data 214 to produce normalized business function classifications 314. Resource allocation system 118 can then determine a corresponding one of set of normalized business function classifications 314 for each employee represented in sets of employee data 214 based on a mode output of statistical classification model 410.

In this manner, resource allocation system 118 determines of normalized business function classifications 314 by applying statistical classification model 410 to sets of employee data 214. In this manner, resource allocation system 118 applies representation learning 402 to determine normalized business function classifications 314 into which each of employees 110 can be segregated.

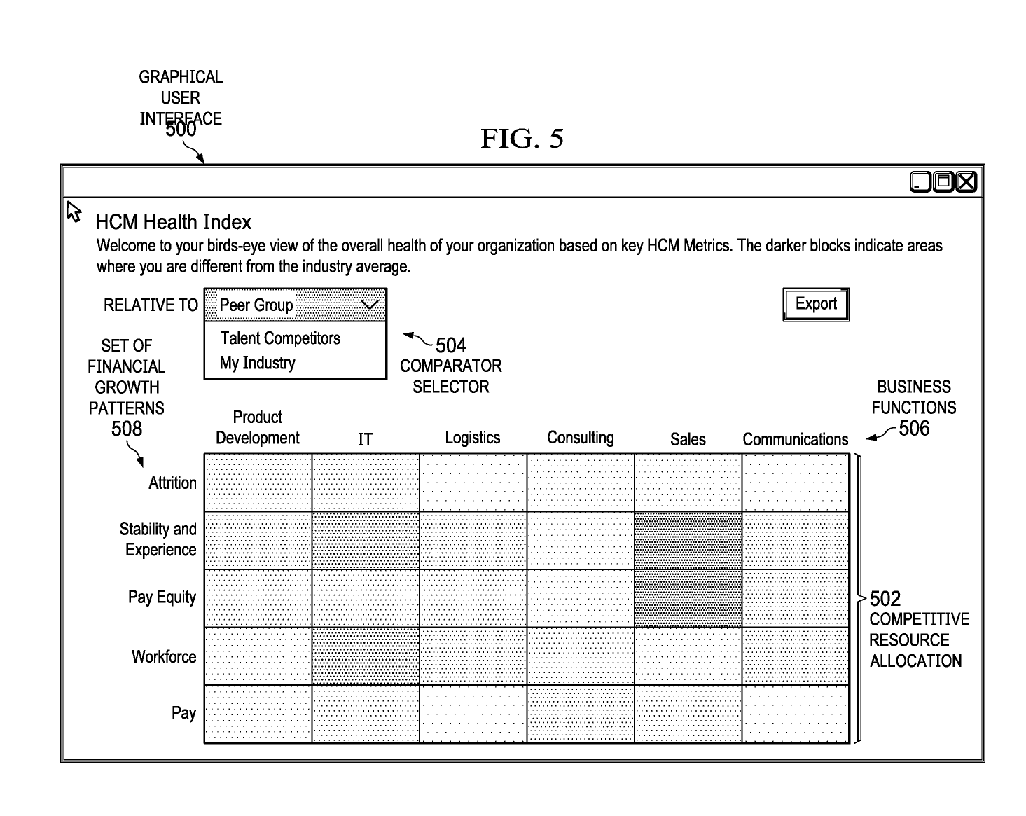

Turning next to FIG. 5, a graphical user interface displaying a competitive resource allocation is depicted according to an illustrative embodiment. Graphical user interface 500 displays competitive resource allocation 502. Competitive resource allocation 502 is an example of competitive resource allocation 124, as shown in block form in FIG. 1. Competitive resource allocation 502 can be digitally presented on a display system, such as display system 143, as shown in block form in FIG. 1.

As depicted, graphical user interface 500 includes comparator selector 504. Comparator selector 504 allows a user to select a category of benchmark organizations, such as sets of benchmark organizations 214 as shown in block form in FIG. 2, from which benchmark distributions, such as benchmark distributions 142 shown in block form in FIG. 1, can be identified.

As depicted, graphical user interface 500 includes set of business functions 506. Set of business functions 506 is a graphical depiction of set of business functions 112, shown in block form in FIG. 1. As depicted, graphical user interface 500 displays competitive resource allocation 502 across set of business functions 506.

As depicted, graphical user interface 500 includes set of financial growth patterns 508. Set of financial growth patterns 508 is a graphical depiction of a set of financial growth patterns 206, shown in block form in FIG. 2. As depicted, graphical user interface 500 displays competitive resource allocation 502 across set of financial growth patterns 508.

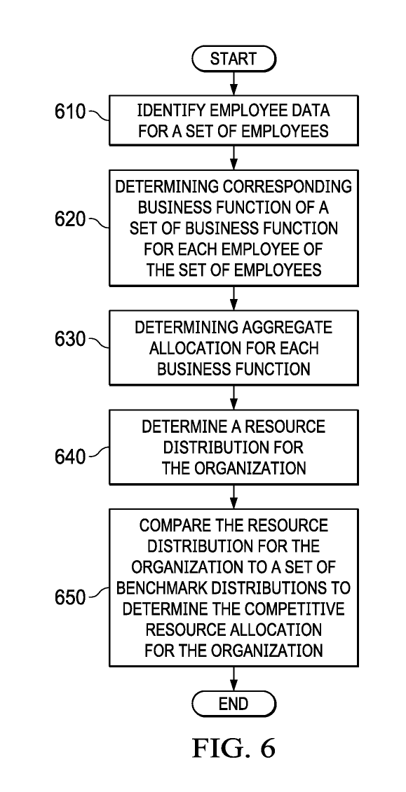

Turning next to FIG. 6, a flowchart of a process for digitally presenting a potentially competitive resource allocation for an organization is depicted according to an illustrative embodiment. Process 600 may be implemented in computer system 122 of FIG. 1. For example, process 600 may be implemented as operations performed by resource allocation system 118, shown in block form in FIG. 1.

Process 600 begins by identifying employee data for a set of employees (step 610). The employee data can be, for example, employee data 126 about employees 110, both shown in block form in FIG. 1.

Process 600 then determines a corresponding business function of a set of business functions for each employee of the set of employees (step 620). The corresponding business function can be determined by applying a normalized business function model, such as normalized business function model 128 shown in block form in FIG. 1, to the employee data.

Next, process 600 determines an aggregate allocation for each business function (step 630). The aggregate allocation can be, for example, aggregate allocation 138 shown in block form in FIG. 1. The aggregate allocation is determined based on a cumulative compensation of a subset of the set of employees, such as subset of employees 132 shown in block form in FIG. 1, in the corresponding business function.

Process 600 then determines a resource distribution for an organization (step 640). The resource distribution can be, for example, resource distribution 140 shown in block form in FIG. 1. The resource distribution can be determined based on the aggregate allocations, such as aggregate allocations 136 shown in block form in FIG. 1, for each of the set of business functions.

Next, process 600 compares the resource distribution for the organization to a set of benchmark distributions to determine the competitive resource allocation for the organization (step 650), with the process terminating thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

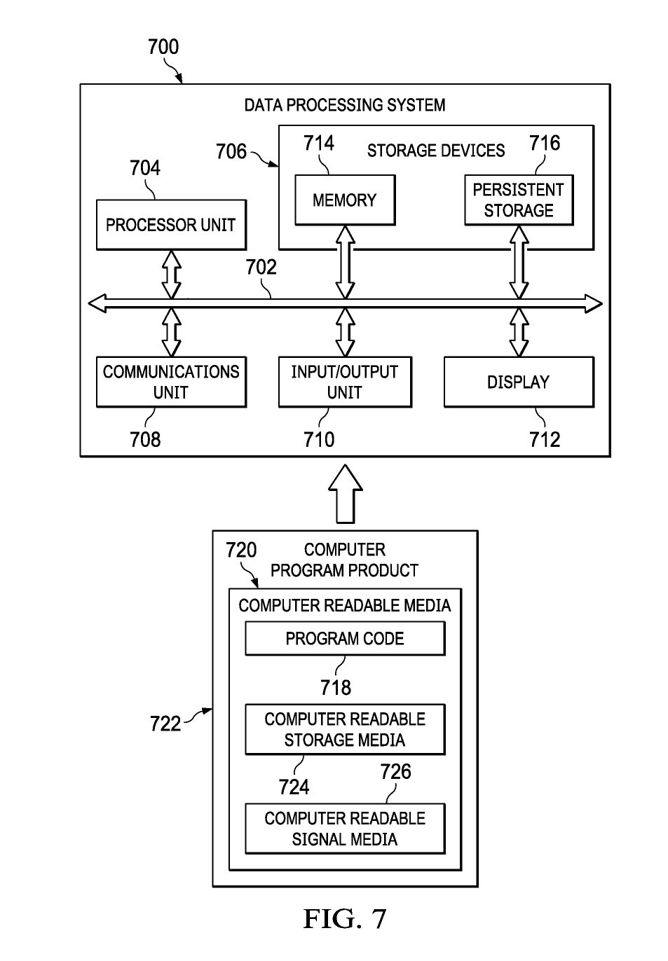

Turning now to FIG. 7, an illustration of a block diagram of a data processing system is depicted in accordance with an illustrative embodiment. Data processing system 700 may be used to implement one or more computers and computer system 122 in FIG. 1. In this illustrative example, data processing system 700 includes communications framework 702, which provides communications between processor unit 704, memory 714, persistent storage 716, communications unit 708, input/output unit 710, and display 712. In this example, communications framework 702 may take the form of a bus system.

Processor unit 704 serves to execute instructions for software that may be loaded into memory 714. Processor unit 704 may be a number of processors, a multi-processor core, or some other type of processor, depending on the particular implementation.

Memory 714 and persistent storage 716 are examples of storage devices 706. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 706 may also be referred to as computer-readable storage devices in these illustrative examples. Memory 714, in these examples, may be, for example, a random access memory or any other suitable volatile or non-volatile storage device. Persistent storage 716 may take various forms, depending on the particular implementation.

For example, persistent storage 716 may contain one or more components or devices. For example, persistent storage 716 may be a hard drive, a flash memory, a rewritable optical disk, a rewritable magnetic tape, or some combination of the above. The media used by persistent storage 716 also may be removable. For example, a removable hard drive may be used for persistent storage 716.

Communications unit 708, in these illustrative examples, provides for communications with other data processing systems or devices. In these illustrative examples, communications unit 708 is a network interface card.

Input/output unit 710 allows for input and output of data with other devices that may be connected to data processing system 700. For example, input/output unit 710 may provide a connection for user input through at least of a keyboard, a mouse, or some other suitable input device. Further, input/output unit 710 may send output to a printer. Display 712 provides a mechanism to display information to a user.

Instructions for at least one of the operating system, applications, or programs may be located in storage devices 706, which are in communication with processor unit 704 through communications framework 702. The processes of the different embodiments may be performed by processor unit 704 using computer-implemented instructions, which may be located in a memory, such as memory 714.

These instructions are referred to as program code, computer-usable program code, or computer-readable program code that may be read and executed by a processor in processor unit 704. The program code in the different embodiments may be embodied on different physical or computer-readable storage media, such as memory 714 or persistent storage 716.

Program code 718 is located in a functional form on computer-readable media 720 that is selectively removable and may be loaded onto or transferred to data processing system 700 for execution by processor unit 704. Program code 718 and computer-readable media 720 form computer program product 722 in these illustrative examples. In one example, computer-readable media 720 may be computer-readable storage media 724 or computer-readable signal media 726.

In these illustrative examples, computer-readable storage media 724 is a physical or tangible storage device used to store program code 718 rather than a medium that propagates or transmits program code 718. Alternatively, program code 718 may be transferred to data processing system 700 using computer-readable signal media 726.

Computer-readable signal media 726 may be, for example, a propagated data signal containing program code 718. For example, computer-readable signal media 726 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 700 are not meant to provide architectural limitations to the manner in which different embodiments may be implemented. The different illustrative embodiments may be implemented in a data processing system including components in addition to or in place of those illustrated for data processing system 700. Other components shown in FIG. 7 can be varied from the illustrative examples shown. The different embodiments may be implemented using any hardware device or system capable of running program code 718.

Thus, the illustrative embodiments provide a method, apparatus, and computer program product for digitally presenting a potentially competitive resource allocation for an organization. By determining a competitive allocation of resources, organization 106 performs operations consistent with competitive resource allocation 124 that allocates resources 108 across set of business functions 112, all shown in block form in FIG. 1, in a manner that is consistent with the resource allocations of other successful organizations based on identified financial growth characteristics.

In this manner, the use of resource allocation system 118, shown in block form in FIG. 1, has a technical effect of determining competitive resource allocation 124 based on set of benchmark distributions 142, shown in block form in FIG. 1, thereby reducing time, effort, or both in the performance of operations supporting set of business functions 112. In this manner, operations performed for organization 106 may be performed more efficiently as compared to currently-used systems that do not include resource allocation system 118. For example, operations such as, but not limited to, at least one of hiring, benefits administration, payroll, performance reviews, forming teams for new products, assigning research projects, or other suitable operations for organization 106, performed consistent with competitive resource allocation 124 allows organization 106 to allocate resources 108 across set of business functions 112 based on identified financial growth characteristics of other organizations.

As a result, computer system 122, shown in block form in FIG. 1, operates as a special purpose computer system in which resource allocation system 118 in computer system 122 enables determining of competitive resource allocation 124 from employee data 126 and benchmark distributions 142 based on one of normalized business function model 128. For example, resource allocation system 118 uses normalized business function model 128 to classify employees 110 into subsets of employees 130 corresponding to set of business functions 112. Resource allocation system 118 determines aggregate allocations 136, shown in block form in FIG. 1, for each of set of business functions 112 based on cumulative compensation 134 of subset of employees 132 in the corresponding one of business function 116. Resource allocation system 118 determines a resource distribution for organization 106 based on aggregate allocations 136 for each of set of business functions 112. Resource allocation system 118 compares the resource distribution for organization 106 to a set of benchmark distributions 142 to determine competitive resource allocation 124 for organization 106. When competitive resource allocation 124 is determined in this manner, competitive resource allocation 124 may be relied upon to perform operations for organization 106 in a manner that is consistent with the resource allocations of other successful organizations based on identified financial growth characteristics.

Thus, resource allocation system 118 transforms computer system 122 into a special purpose computer system as compared to currently available general computer systems that do not have resource allocation system 118. Currently-used general computer systems do not reduce the time or effort needed to determine a potentially competitive resource allocation 124 based on employee data 126 and benchmark distributions 142. Further, currently-used general computer systems do not provide for determining competitive resource allocation 124 based on normalized business function model 128.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for digitally presenting a potentially competitive resource allocation for an organization, the method comprising:
identifying, by a computer system, employee data for a set of employees;
determining, by the computer system, a corresponding business function of a set of business functions for each employee of the set of employees by applying a normalized business function model to the employee data;
determining, by the computer system, an aggregate allocation for each business function based on a cumulative compensation of a subset of the set of employees in the corresponding business function;
determining, by the computer system, a resource distribution for the organization based on the aggregate allocations for each of the set of business functions; and
comparing, by the computer system, the resource distribution for the organization to a set of benchmark distributions to determine the competitive resource allocation for the organization.

2. The method of claim 1, further comprising:
determining a set of benchmark organizations;
determining the set of benchmark distributions based on employee data for the set of benchmark organizations, wherein the benchmark distributions are determined across a number of financial growth characteristics; and
comparing, by the computer system, the resource distribution for the organization to the set of benchmark distributions across the number of financial growth characteristics.

3. The method of claim 2, wherein determining the set of benchmark organizations further comprises:
identifying a set of financial growth patterns for a set of organizations, wherein the set of financial growth patterns comprises revenue patterns, income patterns, and profit patterns; and
selecting the set of benchmark organizations from the set of organizations based on the set of financial growth patterns.

4. The method of claim 1, wherein determining the corresponding business function for each employee further comprises:
determining the corresponding business function based on a classification analysis of the employee data, wherein each of the set of business functions is represented by one of a set of classifications determined from the employee data; and
allocating, by the computer system, each employee to the corresponding business function that has a most similar classification of the set of classifications.

5. The method of claim 1, wherein the set of business functions comprises an accounting and finance function, and administration function, a communications function, a consulting function, a human resources function, and information technology function, a legal function, a logistics and distribution function, a marketing and sales function, and operations function, a product development function, a services function, and a supports function.

6. The method of claim 1, wherein the employee data comprises:
human resources information, payroll information, managerial indicators, and non-managerial indicators.

7. The method of claim 6, wherein the human resources information comprises:
an employee information report of the employee, a standard occupational classification of the employee, a job title of the employee, an EEO-1 job category, a North American Industry Classification System class of the employee, a salary grade of the employee, and age of the employee, and a tenure of the employee at the organization, wherein the payroll information comprises:
an annual base salary of the employee, a bonus ratio of the employee, and overtime pay of the employee, wherein the managerial indicators comprise:
a specific managerial indication, a reporting hierarchy of the organization, a manager level description, and the employee information report of the employee, and wherein the non-managerial indicators comprise:
the specific managerial indication, the reporting hierarchy of the organization, the manager level description, the employee information report of the employee, the standard occupational classification of the employee, the annual base salary of the employee, and a bonus ratio of the employee.

8. The method of claim 1, further comprising:
performing an operation for the organization based on the competitive resource allocation for the organization, wherein the operation is enabled based on the competitive resource allocation for the organization.

9. The method of claim 8, wherein the operation is selected from hiring operations, benefits administration operations, payroll operations, performance review operations, forming teams for new products, and assigning research projects.

10. A computer system comprising:
a display system; and
a resource allocation system in communication with the display system, wherein the resource allocation system is configured to:
identify an employee data for a set of employees;
determine a corresponding business function of a set of business functions for each employee of the set of employees by applying a normalized business function model to the employee data;
determine an aggregate allocation for each business function based on a cumulative compensation of a subset of the set of employees in the corresponding business function;
determine a resource distribution for an organization based on the aggregate allocations for each of the set of business functions; and
compare the resource distribution for the organization to a set of benchmark distributions to determine a competitive resource allocation for the organization.

11. The computer system of claim 10, wherein the resource allocation system is further configured to:
determine a set of benchmark organizations;
determine the set of benchmark distributions based on employee data for the set of benchmark organizations, wherein the benchmark distributions are determined across a number of financial growth characteristics; and
compare the resource distribution for the organization to the set of benchmark distributions across the number of financial growth characteristics.

12. The computer system of claim 11, wherein in determining the set of benchmark organizations, the resource allocation system is further configured to:
identify a set of financial growth patterns for a set of organizations, wherein the set of financial growth patterns comprises revenue patterns, income patterns, and profit patterns; and
select the set of benchmark organizations from the set of organizations based on the set of financial growth patterns.

13. The computer system of claim 10, wherein in determining the corresponding business function for each employee, the resource allocation system is further configured to:
determine the corresponding business function based on a classification analysis of the employee data, wherein each of the set of business functions is represented by one of a set of classifications determined from the employee data; and
allocate each employee to the corresponding business function that has a most similar classification of the set of classifications.

14. The computer system of claim 10, wherein the set of business functions comprises an accounting and finance function, and administration function, a communications function, a consulting function, a human resources function, and information technology function, a legal function, a logistics and distribution function, a marketing and sales function, and operations function, a product development function, a services function, and a supports function.

15. The computer system of claim 10, wherein the employee data comprises:
human resources information, payroll information, managerial indicators, and non-managerial indicators.

16. The computer system of claim 15, wherein the human resources information comprises:
an employee information report of the employee, a standard occupational classification of the employee, a job title of the employee, an EEO-1 job category, a North American Industry Classification System class of the employee, a salary grade of the employee, and age of the employee, and a tenure of the employee at the organization, wherein the payroll information comprises:
an annual base salary of the employee, a bonus ratio of the employee, and overtime pay of the employee, wherein the managerial indicators comprise:
a specific managerial indication, a reporting hierarchy of the organization, a manager level description, and the employee information report of the employee, and wherein the non-managerial indicators comprise:
the specific managerial indication, the reporting hierarchy of the organization, the manager level description, the employee information report of the employee, the standard occupational classification of the employee, the annual base salary of the employee, and a bonus ratio of the employee.

17. The computer system of claim 10, wherein the computer system is further configured to:
perform an operation for the organization based on the competitive resource allocation for the organization, wherein the operation is enabled based on the competitive resource allocation for the organization.

18. The computer system of claim 17, wherein the operation is selected from hiring operations, benefits administration operations, payroll operations, performance review operations, forming teams for new products, and assigning research projects.

19. A computer program product for presenting a potentially competitive resource allocation for an organization, the computer program product comprising:
a computer readable storage media;
program code, stored on the computer readable storage media, for identifying employee data for a set of employees;
program code, stored on the computer readable storage media, for determining a corresponding business function of a set of business functions for each employee of the set of employees by applying a normalized business function model to the employee data;
program code, stored on the computer readable storage media, for determining an aggregate allocation for each business function based on a cumulative compensation of a subset of the set of employees in the corresponding business function;
program code, stored on the computer readable storage media, for determining a resource distribution for the organization based on the aggregate allocations for each of the set of business functions; and
program code, stored on the computer readable storage media, for comparing the resource distribution for the organization to a set of benchmark distributions to determine the competitive resource allocation for the organization.

20. The computer program product of claim 19, further comprising:
program code, stored on the computer readable storage media, for determining a set of benchmark organizations;
program code, stored on the computer readable storage media, for determining the set of benchmark distributions based on employee data for the set of benchmark organizations, wherein the benchmark distributions are determined across a number of financial growth characteristics; and
program code, stored on the computer readable storage media, for comparing the resource distribution for the organization to the set of benchmark distributions across the number of financial growth characteristics.

21. The computer program product of claim 20, wherein program code for determining the set of benchmark organizations further comprises:
program code, stored on the computer readable storage media, for identifying a set of financial growth patterns for a set of organizations, wherein the set of financial growth patterns comprises revenue patterns, income patterns, and profit patterns; and
program code, stored on the computer readable storage media, for selecting the set of benchmark organizations from the set of organizations based on the set of financial growth patterns.

22. The computer program product of claim 19, wherein program code for determining the corresponding business function for each employee further comprises:
program code, stored on the computer readable storage media, for determining the corresponding business function based on a classification analysis of the employee data, wherein each of the set of business functions is represented by one of a set of classifications determined from the employee data; and
program code, stored on the computer readable storage media, for allocating each employee to the corresponding business function that has a most similar classification of the set of classifications.

23. The computer program product of claim 19, wherein the set of business functions comprises an accounting and finance function, and administration function, a communications function, a consulting function, a human resources function, and information technology function, a legal function, a logistics and distribution function, a marketing and sales function, and operations function, a product development function, a services function, and a supports function.

24. The computer program product of claim 19, wherein the employee data comprises:
human resources information, payroll information, managerial indicators, and non-managerial indicators.

25. The computer program product of claim 24, wherein the human resources information comprises:
an employee information report of the employee, a standard occupational classification of the employee, a job title of the employee, an EEO-1 job category, a North American Industry Classification System class of the employee, a salary grade of the employee, and age of the employee, and a tenure of the employee at the organization, wherein the payroll information comprises:
an annual base salary of the employee; a bonus ratio of the employee; and overtime pay of the employee, wherein the managerial indicators comprise:
a specific managerial indication, a reporting hierarchy of the organization, a manager level description, and the employee information report of the employee, and wherein the non-managerial indicators comprise:
the specific managerial indication, the reporting hierarchy of the organization, the manager level description, the employee information report of the employee, the standard occupational classification of the employee, the annual base salary of the employee, and a bonus ratio of the employee.

26. The computer program product of claim 19, further comprising:
program code, stored on the computer readable storage media, for performing an operation for the organization based on the competitive resource allocation for the organization, wherein the operation is enabled based on the competitive resource allocation for the organization.

27. The computer program product of claim 26, wherein the operation is selected from hiring operations, benefits administration operations, payroll operations, performance review operations, forming teams for new products, and assigning research projects.
